(19) United States
(12) Patent Application Publication
(10) Pub. No.: US 2023/0068709 A1
(43) Pub. Date: Mar. 2, 2023

(54) POWER CORD SLIDE CONNECTOR COUPLING

(71) Applicant: Lippert Components, Inc., Elkhart, IN (US)

(72) Inventors: Robert L. TIEDGE, Granger, IN (US); Mark KINDER, Clarks Hill, IN (US)

(21) Appl. No.: 17/898,159

(22) Filed: Aug. 29, 2022

Related U.S. Application Data
(60) Provisional application No. 63/237,821, filed on Aug. 27, 2021.

(51) Int. Cl. H01R 24/66; H01R 13/11; H01R 13/639; H01R 13/58

(52) U.S. Cl. CPC H01R 24/66; H01R 13/113; H01R 13/6395; H01R 13/5845

(57) ABSTRACT

A power cord slide connector coupling includes a power cord, a low-profile connector coupled with the power cord, a receptacle including a housing with a concave opening sized to receive the low-profile connector in an insert direction, and a plug disposed in the receptacle and configured to electrically engage the low-profile connector. The plug includes contact members that are positioned such that with the low-profile connector in the concave opening, the plug engages the low-profile connector by displacing the low profile connector in a connect direction, perpendicular to the insert direction.

### CROSS-REFERENCES TO RELATED APPLICATIONS

This application claims the benefit of U.S. Provisional Patent Application No. 63/237,821, filed Aug. 27, 2021, the entire content of which is herein incorporated by reference.

### STATEMENT REGARDING FEDERALLY SPONSORED RESEARCH OR DEVELOPMENT

Not Applicable.

### BACKGROUND

The invention relates to a power cord and coupling and, more particularly, to a power cord slide connector coupling including a low-profile connector that slides into a locked connection and includes a flat cord to prevent the connectors and cord from extending or hanging too far from a structure wall or power source.

Boats when docked and recreational vehicles (RVs) when camped are typically connectable to a fixed power source to power boat and RV accessories. A 50- or 30-amp power cord connects to the boat or RV at one end and to the fixed power source at an opposite end. Existing cords, however, are oversized and extend straight out from the side of the boat or RV causing undue stress on the connection and the twist ring.

Attempts have been made to remedy these shortcomings. For example, a “dog bone” adapter may be attached. The adapter, however, has its own shortcomings including multiple connection points while still stressing the twist ring.

Additionally, safety issues arise when individuals trip or tug the cord coming out from the boat or RV or trip over the cord laying on the ground. Due to the configuration of existing connectors, the plug can be easily disconnected.

Still further, existing plugs do a poor job of preventing contamination from environmental effects such as water, dirt and the like.

### SUMMARY

It would be desirable to provide a power cord slide connector coupling that overcomes the shortcomings with existing configurations.

The connector coupling of the described embodiments is configured to slide into a locked connection and includes a flat cord to prevent the connectors and cord from extending or hanging too far away from the structure wall or power source. The coupling greatly reduces the trip hazard and accidental pulling of the connector from the boat/RV. The coupling also eliminates the need for an adapter or additional connection components, reduces stress on the connector from the weight of the cord, and prevents water and dirt intrusion.

In an exemplary embodiment, a power cord slide connector coupling includes a power cord, and a female connector coupled with the power cord. The female connector includes a plurality of contact openings associated with internal wiring, where the contact openings have an offset stepped configuration. A receptacle includes a housing with a concave opening sized to receive the female connector, and a plug disposed in the receptacle includes a plurality of pins corresponding to the contact openings in the female connector. The plurality of pins are arranged in a reverse offset stepped configuration in complement with the offset stepped configuration of the contact openings.

The female connector may include an upper right angle section and a lower stepped section with the contact openings. The lower stepped section may include a pair of shoulders and a bottom block that extends from the shoulders. The plurality of contact openings may include four contact openings with one of the contact openings in each of the shoulders and two of the contact openings in the bottom block. The plug may include a pair of ledges and a recess that extends from and between the pair of ledges, where the pair of ledges may be engageable with the pair of shoulders, and the bottom block may be engageable with the recess. The plurality of pins may include four pins with one of the pins in each of the ledges and two of the pins in the recess, where the pins in the ledges are connectable with the contact openings in the shoulders, and where the pins in the recess are connectable with the contact openings in the bottom block.

The plug may be embedded in the receptacle.

The concave opening of the housing may be sized and shaped to receive the female connector with the contact openings spaced and disconnected from the pins. The plug may include a pair of ledges and a recess that extends from and between the pair of ledges.

The female connector may include finger grips or finger recesses.

The female connector may include a flange, where the receptacle may include a slot that may be sized to receive the flange. The flange may engage the slot when the contact openings in the female connector are engaged with the pins in the plug. The female connector may include a molded strain relief in which the power cord may be housed, and the flange may be positioned between the molded strain relief and the contact openings.

The power cord slide connector coupling may include a hinged plate connected to the housing of the receptacle. In some embodiments, an underside of the hinged plate may include a wedge that may be insertable between the female connector and the housing, where the wedge urges the female connector into engagement with the plug as the hinged plate is pivoted toward a closed position.

In another exemplary embodiment, a method of connecting a power cord with a female connector to a plug disposed in a receptacle includes the steps of (a) inserting the female connector into the receptacle in an insert direction with the contact openings aligned with and spaced from the pins; and (b) displacing the female connector in a connect direction, perpendicular to the insert direction, to thereby engage the contact openings with the pins. The method may further include urging the female connector into engagement with the plug by pivoting the hinged plate toward a closed position.

In yet another exemplary embodiment, a power cord slide connector coupling includes a power cord, a low-profile connector coupled with the power cord, a receptacle including a housing with a concave opening sized to receive the low-profile connector in an insert direction, and a plug disposed in the receptacle and configured to electrically engage the low-profile connector. The plug includes contact members, and the contact members are positioned such that with the low-profile connector in the concave opening, the plug engages the low-profile connector by displacing the low-profile connector in a connect direction, perpendicular to the insert direction.

### BRIEF DESCRIPTION OF THE DRAWINGS

These and other aspects and advantages will be described in detail with reference to the accompanying drawings, in which:

FIG. 1 shows the power cord and female connector;

FIG. 2 shows the receptacle and pins;

FIG. 3 shows the connector in position to engage the receptacle;

FIGS. 4 and 5 illustrate the process for securing the connector to the pins in the receptacle;

FIG. 6 shows the receptacle including a hinged plate;

FIG. 7 shows the connector engaging the receptacle with the hinged plate in a closed or closing position;

FIG. 8 shows an alternative configuration of the female connector;

FIG. 9 shows the FIG. 8 configuration with the hinged plate in a closed position;

FIG. 10 shows an extension cord receiver and pins; and

FIGS. 11 and 12 illustrate the process for securing the power cord and female connector to the pins in the extension cord receiver.

### DETAILED DESCRIPTION

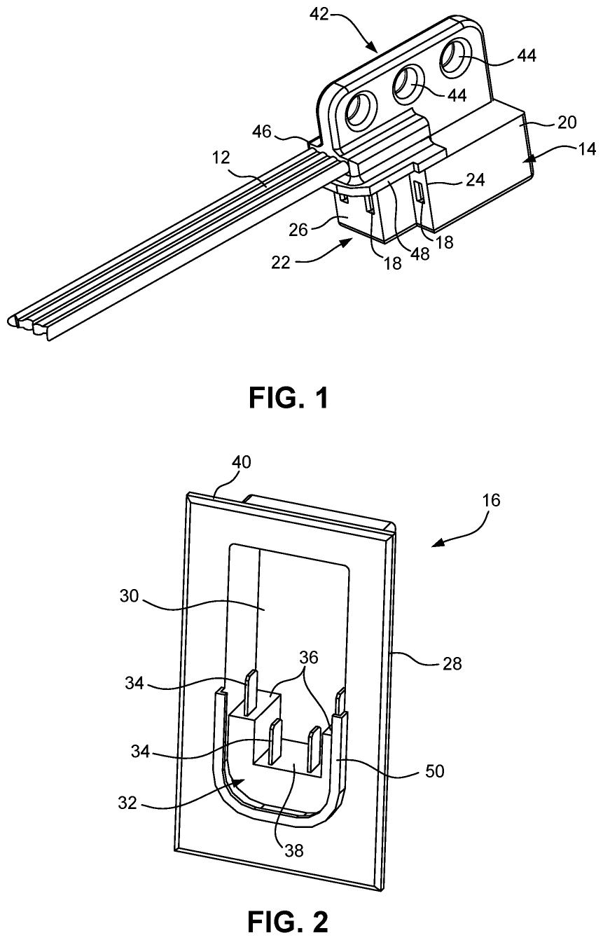

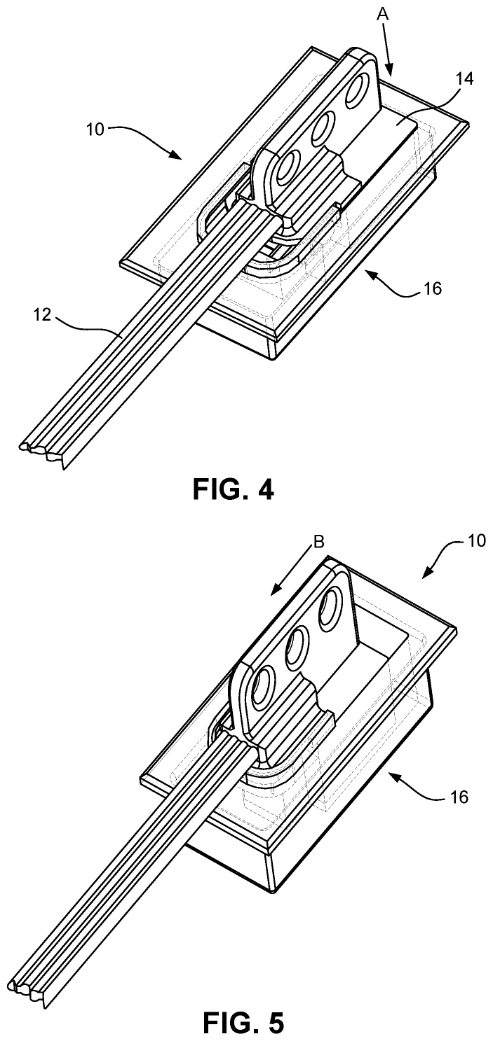

With reference to FIGS. 1-3, the power cord slide connector coupling 10 of the described embodiments includes a flat power cord 12 with a connector 14 and a receptacle 16. An exemplary flat power cord is described in the assignee's U.S. patent application Ser. No. 17/387,729, the contents of which are hereby incorporated by reference.

In some embodiments, the flat power cord 12 is electrically secured to the connector 14, and the connector 14 is a female connector including a plurality of contact openings 18 associated with internal wiring. The internal wiring is conventional to a NEMA 14-50R connector. The opposite end of the power cord 12 is provided with a standard male NEMA TT-30P connector to connect with the fixed power source.

The female connector 14 includes an upper right angle section 20 and a lower stepped section 22 with the contact openings 18. The lower stepped section 22 includes a pair of shoulders 24 and a bottom block 26 that extends from the shoulders 24. In some embodiments, the connector 14 includes four contact openings 18 with one of the contact openings 18 in each of the shoulders 24 and two of the contact openings 18 in the bottom block 26. The contact openings 18 are thus provided with an offset stepped configuration via the shoulders 24 and the bottom block 26. Alternative offset stepped configurations may be viable, and the invention is not necessarily meant to be limited to the illustrated configuration.

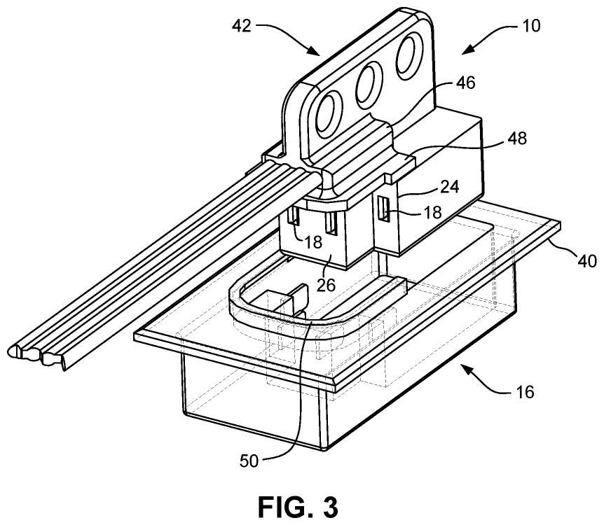

The receptacle 16 includes a housing 28 with a concave opening 30 sized to receive the female connector 14. A plug 32 is disposed in the receptacle 16 and includes a plurality of pins 34 corresponding to the contact openings 18 in the female connector 14. In some embodiments, the plug 32 is embedded in the bottom of the receptacle 16. As shown, the plurality of pins 34 are arranged in a reverse offset stepped configuration in complement with the offset stepped configuration of the contact openings 18. Specifically, in an exemplary embodiment with reference to FIG. 2, the plug 32 may include a pair of ledges 36 and a recess 38 that extends from and between the pair of ledges 36. The pair of ledges 36 are engageable with the pair of shoulders 24, and the bottom block 26 is engageable with the recess 38. In some embodiments, the plug 32 includes four pins 34 with one of the pins 34 in each of the ledges 36 and two of the pins 34 in the recess 38. The pins 34 in the ledges 36 are connectable with the contact openings 18 in the shoulders 24, and the pins 34 in the recess 38 are connectable with the contact openings 18 in the bottom block 26.

The receptacle 16 includes the concave opening 30 in a front open face with flanges 40 that have larger dimensions than the other faces of the housing 28 to facilitate installation of the housing 28 into a boat or RV wall. The receptacle 16 may be recessed within an opening in the vehicle wall so that the front open face of the housing 28 is substantially flush with the vehicle wall and so that the engaged and locked power cord coupling does not extend substantially outwardly from the vehicle wall.

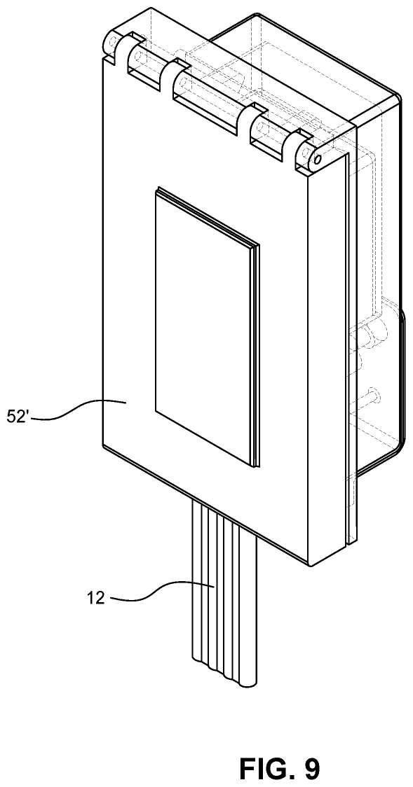

The connector 14 may also include a handle 42 with finger holes 44 or finger slots/grips 45 (FIG. 8) for gripping and maneuvering the female connector 14. The power cord 12 enters a molded strain relief 46 that is integrated between the handle 42 and the upper right angle section 20 and the lower stepped section 22 of the connector 14.

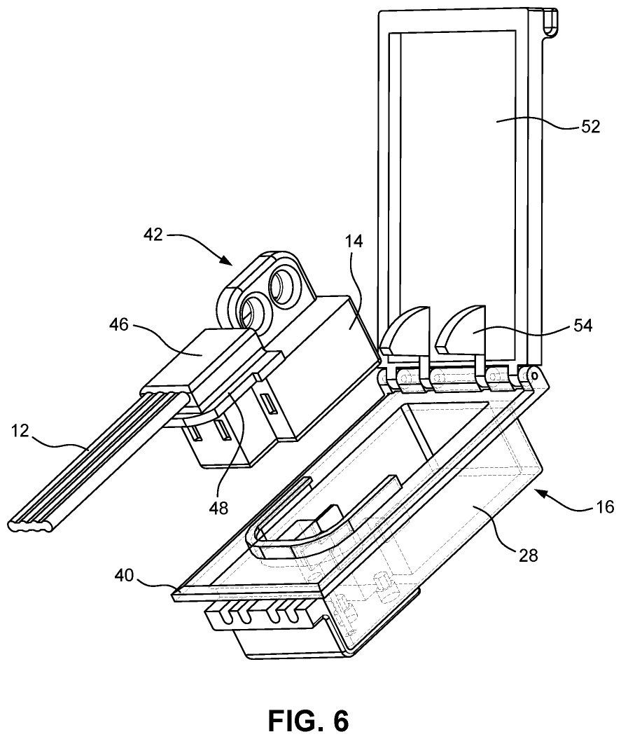

With reference to FIGS. 4 and 5, the concave opening 30 of the housing 28 is sized and shaped to receive the female connector 14 with the contact openings 18 spaced from and aligned with the pins 34 (FIG. 4). The female connector 14 is inserted into the receptacle 16 in an insert direction (arrow A in FIG. 4). As shown in FIG. 5, the female connector 14 is subsequently displaced in a connect direction (arrow B in FIG. 5), perpendicular to the insert direction, to thereby engage the contact openings 18 with the pins 34. The handle 42 facilitates displacement of the female connector 14 in the connect direction.

The female connector 14 may include a flange 48 positioned between the molded strain relief 46 and the contact openings 18. The receptacle 16 may include a corresponding slot 50 that is sized to receive the flange 48. The flange 48 engages the slot 50 when the contact openings 18 in the female connector 14 are displaced into engagement with the pins 34 in the plug 32. In some embodiments, the slot 50 is a semi-circular and L-shaped slot that extends from the outer surface of the front face to receive and secure the semi-circular flange 48 of the female connector 14. The overall construction of the coupling serves to minimize intrusion of water and dirt and the like into the receptacle 16.

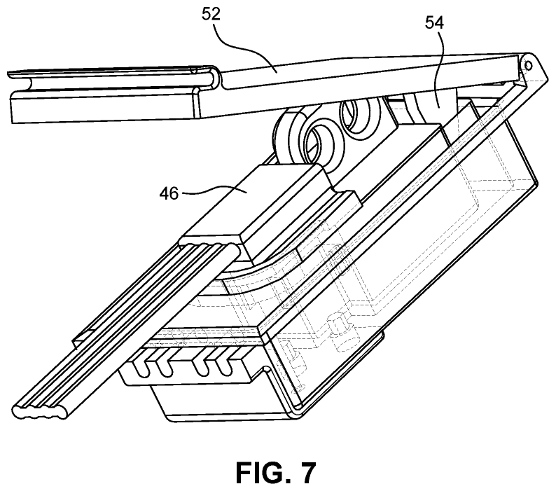

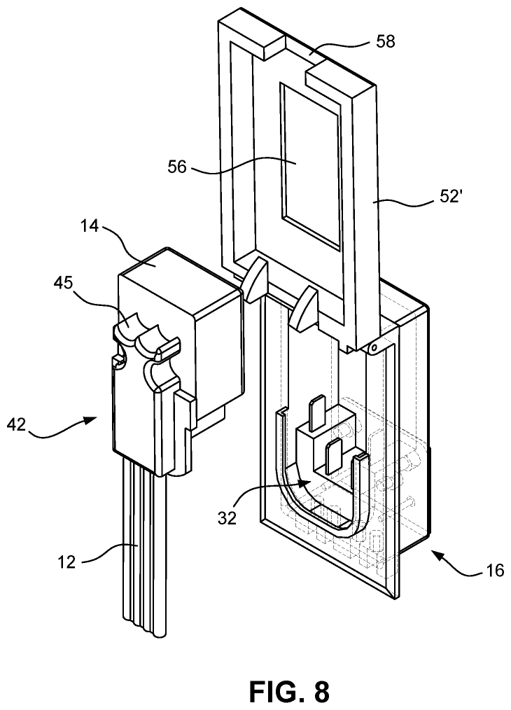

At a top portion, the receptacle 16 may include a hinged plate or cover 52 that may be spring-loaded. The hinged plate 52 protects the top of the receptacle whether or not it is in use. An underside of the hinged plate 52 may be provided with one or more wedges 54 that are insertable between the female connector 14 and the housing 28 (see FIGS. 6 and 7). As shown in FIG. 7, the wedge 54 urges the female connector 14 into engagement with the plug 32 as the hinged plate 52 is pivoted toward a closed position. The wedges 54 prevent the power cord connector from accidental sliding or disconnection from the receptacle.

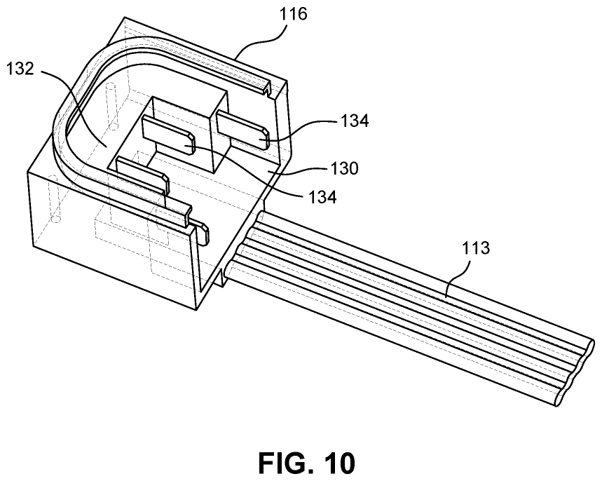

The only component that protrudes from the wall is the power cord handle 42 for engaging and disengaging the coupling. The hinged plate 52 may protrude minimally. Other handle styles or grips including lower-profile designs could also be used. For example, FIG. 8 shows the handle 42 including shaped finger slots or grips 45 that protrudes minimally from the front of the connector 14. In this embodiment, a modified hinged plate 52′ may include a raised center rectangle 56 and a cutout 58 in the bottom of the modified plate 52′ to accommodate the low profile power cord connector and to completely close and be flush with the receptacle housing. See FIG. 9.

The receptacle has a right angle shape at the top of the opening, and the plug is embedded at the bottom of the opening containing two offset pairs of pins. A top and bottom of the concave receptacle are spaced so that the female connector end of the power cord may be inserted into the receptacle within the right-angle top without contacting or being obstructed by the plug. The user gripping the handle or slots may then slide the female connector downward so that the four pins of the receptacle insert and lock with the four contact openings of the female connector. The contact opening side of the female connector is shaped to accommodate for the offset pairs of pins in the receptacle.

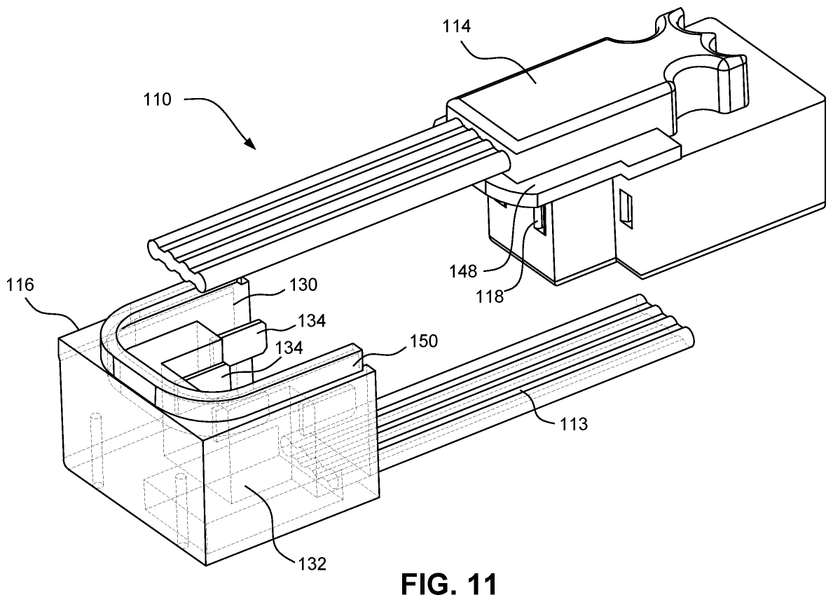

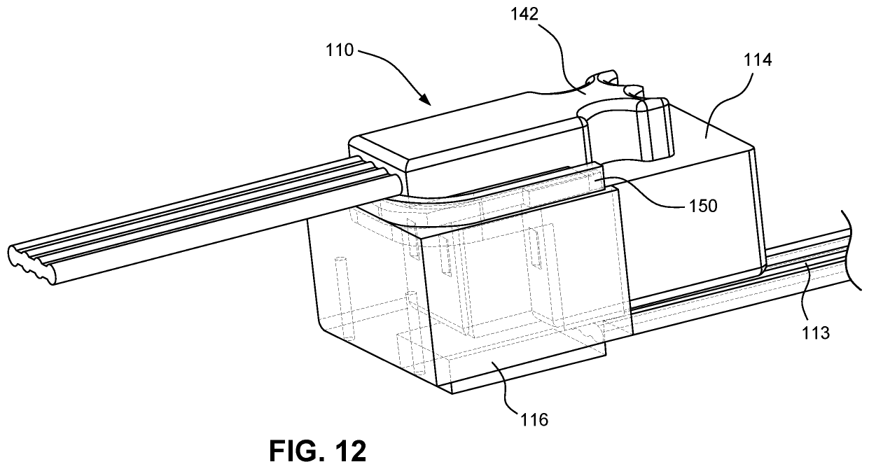

FIGS. 10-12 show an alternate embodiment of a power cord slide connector extension cord coupling 110. The female connector and power cord illustrated in this embodiment are identical to the female connector and power cord described above but are indicated with the same reference numbers increased by 100.

An extension cord receiver 116 receives the female connector 114 in a manner similar to the above power cord slide connector coupling 10. The extension cord receiver 116 is similar in construction to the receptacle 16 except that it has an open top and does not include outer flanges. The extension cord receiver 116 is electrically connected to an extension cord 113 that includes another female connector at its opposite end for connecting to vehicle power. In a preferred embodiment, the extension cord is a flat power cord, and the female connector is identical to the female connector 14 of the above embodiments for connecting to the receptacle 16.

The extension cord receiver 116 has an open top, and a plug 132 is embedded at the bottom of the opening 130 containing two offset pairs of pins 134. The open top of the concave receiver 116 is sized so that the female connector end of the power cord may be inserted into the open top of the receiver. The user gripping the handle or slots 142 may slide the female connector 114 downward into direct connection with the plug 132 so that the four pins 134 of the receiver 116 insert and lock with the four contact openings 118 of the female connector 114. The contact opening side of the female connector 114 is shaped to accommodate for the offset pairs of pins in the receiver. The flange 148 of the female connector 114 may engage a slot 150 on the receiver 116 when the contact openings 118 in the female connector 114 are displaced into engagement with the pins 134 in the receiver 116. The overall construction of the extension cord coupling 110 serves to minimize intrusion of water and dirt and the like into the receiver 116.

The connector may alternatively include pins rather than contact openings, and the receptacle or extension cord receiver may alternatively include contact openings engageable with the pins.

The overall construction of the coupling serves to minimize intrusion of water and/or dirt and the like into the receptacle or receiver.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A power cord slide connector coupling comprising:
a power cord;
a female connector coupled with the power cord, the female connector including a plurality of contact openings associated with internal wiring, the contact openings having an offset stepped configuration;
a receptacle including a housing with a concave opening sized to receive the female connector; and
a plug disposed in the receptacle and including a plurality of pins corresponding to the contact openings in the female connector, wherein the plurality of pins are arranged in a reverse offset stepped configuration in complement with the offset stepped configuration of the contact openings.

2. A power cord slide connector coupling according to claim 1, wherein the female connector includes an upper right angle section and a lower stepped section with the contact openings.

3. A power cord slide connector coupling according to claim 2, wherein the lower stepped section comprises a pair of shoulders and a bottom block that extends from the shoulders.

4. A power cord slide connector coupling according to claim 3, wherein the plurality of contact openings comprise four contact openings with one of the contact openings in each of the shoulders and two of the contact openings in the bottom block.

5. A power cord slide connector coupling according to claim 4, wherein the plug comprises a pair of ledges and a recess that extends from and between the pair of ledges, the pair of ledges being engageable with the pair of shoulders, and the bottom block being engageable with the recess.

6. A power cord slide connector coupling according to claim 5, wherein the plurality of pins comprise four pins with one of the pins in each of the ledges and two of the pins in the recess, wherein the pins in the ledges are connectable with the contact openings in the shoulders, and wherein the pins in the recess are connectable with the contact openings in the bottom block.

7. A power cord slide connector coupling according to claim 1, wherein the plug is embedded in the receptacle.

8. A power cord slide connector coupling according to claim 1, wherein the concave opening of the housing is sized and shaped to receive the female connector with the contact openings spaced and disconnected from the pins.

9. A power cord slide connector coupling according to claim 8, wherein the plug comprises a pair of ledges and a recess that extends from and between the pair of ledges.

10. A power cord slide connector coupling according to claim 9, wherein the plurality of pins comprise four pins with one of the pins in each of the ledges and two of the pins in the recess.

11. A power cord slide connector coupling according to claim 1, wherein the female connector comprises finger grips or finger recesses.

12. A power cord slide connector coupling according to claim 1, wherein the female connector comprises a flange, and wherein the receptacle comprises a slot that is sized to receive the flange, wherein the flange engages the slot when the contact openings in the female connector are engaged with the pins in the plug.

13. A power cord slide connector coupling according to claim 12, wherein the female connector comprises a molded strain relief in which the power cord is housed, and wherein the flange is positioned between the molded strain relief and the contact openings.

14. A power cord slide connector coupling according to claim 1, further comprising a hinged plate connected to the housing of the receptacle.

15. A power cord slide connector coupling according to claim 14, wherein an underside of the hinged plate comprises a wedge that is insertable between the female connector and the housing, the wedge urging the female connector into engagement with the plug as the hinged plate is pivoted toward a closed position.

16. A method of connecting a power cord with a female connector to a plug disposed in a receptacle, the female connector including a plurality of contact openings associated with internal wiring and having an offset stepped configuration, the plug including a plurality of pins corresponding to the contact openings in the female connector arranged in a reverse offset stepped configuration in complement with the offset stepped configuration of the contact openings, the method comprising:
(a) inserting the female connector into the receptacle in an insert direction with the contact openings aligned with and spaced from the pins; and
(b) displacing the female connector in a connect direction, perpendicular to the insert direction, to thereby engage the contact openings with the pins.

17. A method according to claim 16, further including a hinged plate connected to the receptacle, wherein an underside of the hinged plate includes a wedge that is insertable between the female connector and the receptacle, the method comprising urging the female connector into engagement with the plug by pivoting the hinged plate toward a closed position.

18. A power cord slide connector coupling comprising:
a power cord;
a low-profile connector coupled with the power cord;
a receptacle including a housing with a concave opening sized to receive the low-profile connector in an insert direction; and
a plug disposed in the receptacle and configured to electrically engage the low-profile connector, the plug including contact members, wherein the contact members are positioned such that with the low-profile connector in the concave opening, the plug engages the low-profile connector by displacing the low-profile connector in a connect direction, perpendicular to the insert direction.
